(19) United States
(12) Patent Application Publication
(10) Pub. No.: US 2025/0201941 A1
(43) Pub. Date: Jun. 19, 2025

(54) BATTERY MANAGEMENT SYSTEM, BATTERY MANAGEMENT METHOD, AND PROGRAM

(71) Applicant: Renesas Electronics Corporation, Tokyo (JP)

(72) Inventors: Tetsuji TSUDA, Tokyo (JP); Shunichi KAERIYAMA, Tokyo (JP); Takuya YOSHINAGA, Tokyo (JP)

(21) Appl. No.: 18/929,775

(22) Filed: Oct. 29, 2024

(30) Foreign Application Priority Data
Dec. 14, 2023 (JP) 2023-211363

(51) Int. Cl. H01M 10/42; H01M 10/48; H02J 7/00

(52) U.S. Cl. CPC H01M 10/425; H01M 10/482; H01M 10/486; H02J 7/00036; H02J 7/0048; H02J 7/00714; H02J 7/007182; H02J 7/007194; H01M 2010/4271; H01M 2010/4278

(57) ABSTRACT

The battery management system includes a first communication connection checking unit, a second communication connection checking unit, and an estimating unit. The first communication connection checking unit checks the communication state of the first communication connection that connects the microcontroller and the battery managing unit that obtains the cell voltage and the pack temperature. The second communication connection checking unit checks the communication state of the second communication connection that connects the microcontroller and the measuring unit that measures the pack voltage and pack current. The estimating unit estimates the charge/discharge information for controlling the charge/discharge of the battery based on the information that the microcontroller MC1 can be obtained, in accordance with the communication state of the first communication connection and the second communication connection.

### CROSS-REFERENCE TO RELATED APPLICATIONS

The disclosure of Japanese Patent Application No. 2023-211363 filed on Dec. 14, 2023, including the specification, drawings and abstract is incorporated herein by reference in its entirety.

### BACKGROUND

The present invention relates to a battery management system, a battery management method, and a program. It relates to a battery management system, a battery management method, and a program suitable for estimating information for controlling discharging charge even if measurement results are not sufficiently obtained.

In recent years, with the popularization of electric vehicles, the development of technology related to batteries has been carried out. In the battery, the voltage of each cell, the pack temperature of the battery pack, the pack current of the battery pack, and the pack voltage of the battery pack are measured, and the state of charge is estimated from the measurement result. Then, in the battery, for example, continuing or aborting the charge/discharge of the battery from the temperature or the charging state is controlled.

### SUMMARY

In the battery, it is required to estimate the information for controlling the charge/discharge even if the measurement result is not sufficiently obtained. Other objects and novel features will become apparent from the description of this specification and the accompanying drawings.

The battery management system of the present disclosure comprises a first communication connection checking unit for checking a first communication state of a first communication connection that connects a microcontroller and a battery managing unit that obtains a cell voltage of a plurality of cells and a pack temperature of a battery pack, a second communication connection checking unit for checking a second communication state of a second communication connection that connects the microcontroller and a measuring unit for measuring the pack voltage and the pack current of the battery pack, and an estimating unit for estimating the charge/discharge information for controlling charge/discharge of the battery based on the information that the microcontroller can obtain, in response to the first communication state and the second communication state.

The battery management method according to the present disclosure is executed by a computer, the method comprises checking a first communication state of a first communication connection that connects a microcontroller and the battery managing unit that obtains a cell voltages of a plurality of cells and the pack temperature of a battery pack, and checking a second communication state of a second communication connection that connects the microcontroller and a measuring unit for measuring the pack voltage and pack current of the battery pack, and estimating charge/discharge information for controlling the charge/discharge of the battery, based on the information the microcontroller can obtain, in response to the first communication state and the second communication state.

The program according to the present disclosure causes a CPU to execute following processes: checking the communication state of the first communication connection connecting the microcontroller and the battery managing unit that obtains the cell voltages of the plurality of cells and the pack temperature of the battery pack, and checking the communication state of the second communication connection connecting the microcontroller, the measuring unit for measuring the pack voltage and pack current of the battery pack, and estimating the charge/discharge information for controlling the charge/discharge of the battery, based on the information the microcontroller can obtain, in response to the communication state of the first communication connection and the second communication connection.

The present disclosure can provide a battery management system, a battery management method, and a program capable of estimating information for controlling charge/discharge even if measurement results are not sufficiently obtained.

### BRIEF DESCRIPTION OF THE DRAWINGS

FIG. 1 is a block diagram showing a battery management system according to a first embodiment.

FIG. 2 is a flowchart showing a battery management method according to the first embodiment.

FIG. 3 is a block diagram showing a battery management system according to a second embodiment.

FIG. 4 is a block diagram showing a battery management system according to the second embodiment.

FIG. 5A is a diagram showing the relationship between the state of charge and the cell voltage of the cell.

FIG. 5B is a diagram showing the relationship between the state of charge and the pack voltage of the battery.

FIG. 6A is a diagram showing a change in the pack current in response to time.

FIG. 6B is a diagram showing a change in the pack temperature in response to time, the relationship between change.

FIG. 6C is a diagram showing the relation between the pack current and the pack temperature.

FIG. 7 is a block diagram showing a battery management system according to a second embodiment.

FIG. 8 is a diagram showing the relationship between the state of charge and the pack voltage of the battery at each temperature.

FIG. 9 is a block diagram showing a battery management system according to a third embodiment.

FIG. 10 is a diagram showing the relationship between the state of charge and the pack voltage of the battery at each temperature.

FIG. 11 is a diagram showing the relationship between the state of charge and the pack voltage of the battery at each temperature.

FIG. 12 is a block diagram showing a battery management system according to a fourth embodiment.

### DETAILED DESCRIPTION

Hereinafter, an embodiment will be described with reference to the drawings. Since the drawings are simplified, the technical scope of the embodiment should not be narrowly interpreted on the basis of the description of the drawings. Further, the same elements are denoted by the same reference numerals, without redundant description.

In the following embodiments, where it is necessary for convenience, it will be described by dividing it into multiple sections or embodiments. However, unless otherwise specified, they are not mutually related, one is in the relationship of some or all modifications of the other, examples of application, detailed description, supplemental explanation, etc. In the following embodiments, the number of elements, etc. (including the number of elements, numerical values, quantities, ranges, etc.) is not limited to the specific number, but may be not less than or equal to the specific number, except for cases where the number is specifically indicated and is clearly limited to the specific number in principle.

Furthermore, in the following embodiments, the constituent elements (including the operation steps and the like) are not necessarily essential except in the case where they are specifically specified and the case where they are considered to be obviously essential in principle. Similarly, in the following embodiments, when referring to the shapes, positional relationships, and the like of components and the like, it is assumed that the shapes and the like are substantially approximate to or similar to the shapes and the like, except for the case in which they are specifically specified and the case in which they are considered to be obvious in principle, and the like. The same applies to the above-mentioned numbers and the like, including the number, the numerical value, the amount, the range, and the like.

### First Embodiment

### (Battery Management System)

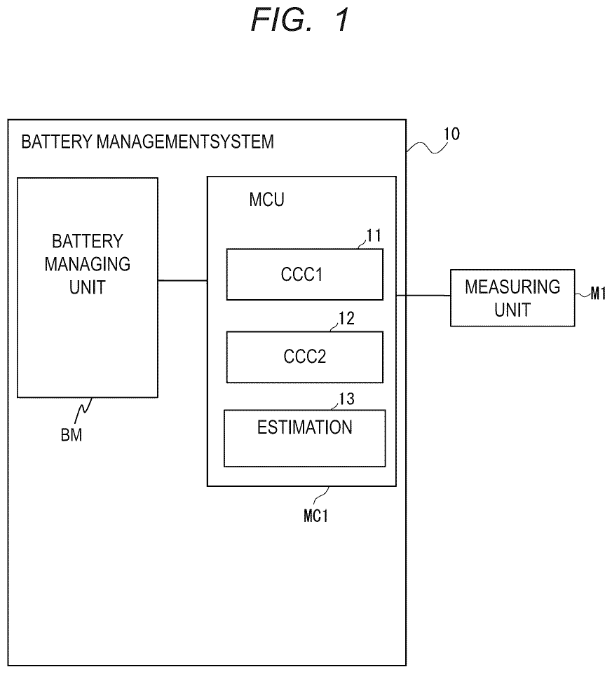

Hereinafter, the configuration of the battery management system and the battery according to the first embodiment will be described with reference to the drawings. FIG. 1 is a block diagram showing a battery management system according to a first embodiment. As shown in FIG. 1, the battery management system 10 includes a microcontroller MC1 and a battery managing unit BM. In the exemplary embodiment shown in FIG. 1, the microcontroller (MCU) MC1 includes a first communication connection checking unit (CCC1) 11, a second communication connection checking unit (CCC2) 12, and an estimating unit (ESTIMATION) 13. A measuring unit Ml is provided outside the battery management system 10.

As shown in FIG. 1, the microcontroller MC1 and the battery managing unit BM are connected by a communicable configuration. The communication connection between the microcontroller MC1 and the battery managing unit BM is referred to as a first communication connection.

Further, as shown in FIG. 1, the microcontroller MC1 and the measuring unit Ml are connected by a communicable configuration. The connection between the microcontroller MC1 and the measuring unit M1 is referred to as a second communication connection.

The first communication connection is not limited to a wired connection and may be a wireless connection. The first communication connection checking unit 11 checks the communication state of the first communication connection. More specifically, the first communication connection checking unit 11 determines whether the communication state of the first communication connection is a disconnected state or not.

The second communication connection is a wired connection. The second communication connection checking unit 12 checks the communication state of the second communication connection. More specifically, the second communication connection checking unit 12 determines whether the communication state of the second communication connection is a disconnected state or not.

The battery managing unit BM obtains the cell voltages of the plurality of cells and the pack temperature of the battery pack. The measuring unit M1 measures the pack voltage and pack current of the battery pack.

The microcontroller MC1 and the battery managing unit BM are communicated with each other through the first communication connection. Thus, the microcontroller MC1 obtains the cell voltage obtained by the battery managing unit BM and the pack temperature of the battery pack.

In addition, the microcontroller MC1 and the measuring unit M1 are communicated with each other through the second communication connection. Thus, the microcontroller MC1 obtains the pack voltage and pack current of the battery pack measured by the measuring unit M1.

That is, the microcontroller MC1 obtains the cell voltages, the pack temperatures, the pack voltages, and the pack currents of the plurality of cells when the first communication connection and the second communication connection are in the communication state. For example, when the first communication connection is in the disconnected state and the second communication connection is in the communication state, the microcontroller MC1 can obtain the cell voltages and pack temperatures of the plurality of cells, but can obtain the pack voltage and pack current. Thus, depending on the communication state of the first communication connection and the second communication connection, the information that the microcontroller MC1 can obtain differs.

The estimating unit 13, in response to the communication state of the first communication connection and the second communication connection, based on the information obtained by the microcontroller MC1, estimates the charge/discharge information for controlling the charge/discharge of the battery.

That is, when the communication state of the first communication connection and the second communication connection is connected, the estimating unit 13 estimates the charge/discharge information for controlling the charge/discharge of the battery based on the information from the first communication connection or the second communication connection communication state. When the communication state of the first communication connection and the second communication connection is disconnected, the estimating unit 13 estimates the charge/discharge information for controlling the charge/discharge of the battery based on the information obtained by the microcontroller before the communication state of the first communication connection and the second communication connection is disconnected.

Thus, according to the communication state of the first communication connection and the second communication connection, the battery management system 10 according to the first embodiment estimates the charge/discharge information for controlling the charge/discharge of the battery based on the information obtained by the microcontroller MC1. Thus, the battery management system 10 can estimate the information for controlling the charge/discharge even when the measuring result is not sufficiently obtained.

### (Battery Management Method)

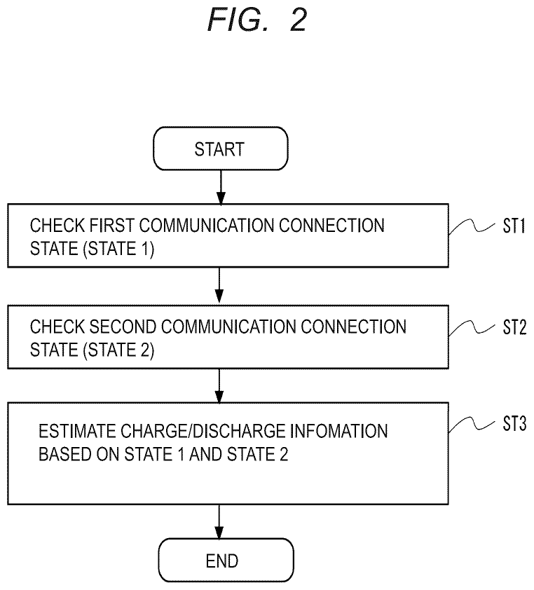

Subsequently, the battery management method according to the first embodiment will be described. FIG. 2 is a flowchart showing a battery management method according to the first embodiment. The main components of each step are the first communication connection checking unit 11 shown in FIG. 1, the second communication connection checking unit 12, and the estimating unit 13.

First, the first communication connection checking unit 11 checks the communication state of the first communication connection that connects the microcontroller and the battery management unit that obtains the cell voltages of the plurality of cells and the pack temperature of the battery pack (in step ST1).

Next, the second communication connection checking unit 12 checks the communication state of the second communication connection that connects the microcontroller and the measuring unit that measures the pack voltage and the pack current of the battery pack (in step ST2).

Next, the estimating unit 13 estimates the charge/discharge information for controlling the charge/discharge of the battery based on the information obtained by the microcontroller, in response to the communication state of the first communication connection and the second communication connection (in step ST3).

Thus, the battery management method according to the first embodiment estimates the charge/discharge information for controlling the charge/discharge of the battery based on the information obtained by the microcontroller in response to the communication state of the first communication connection and the second communication connection. Thus, the battery management method according to the first embodiment can estimate the information for controlling the charge/discharge charge even when the measuring result is not sufficiently obtained.

### Second Embodiment

### (Battery Configuration)

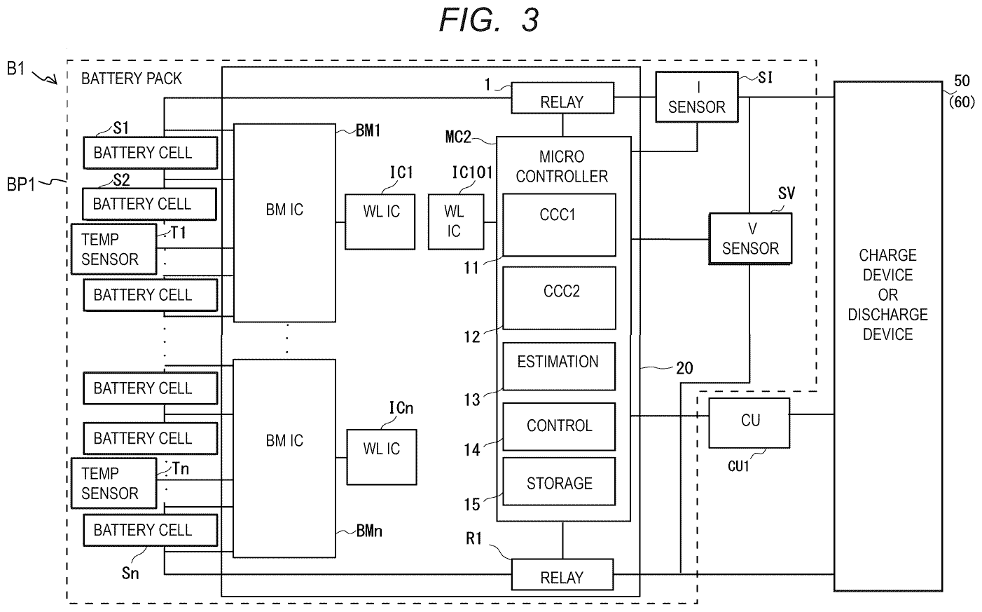

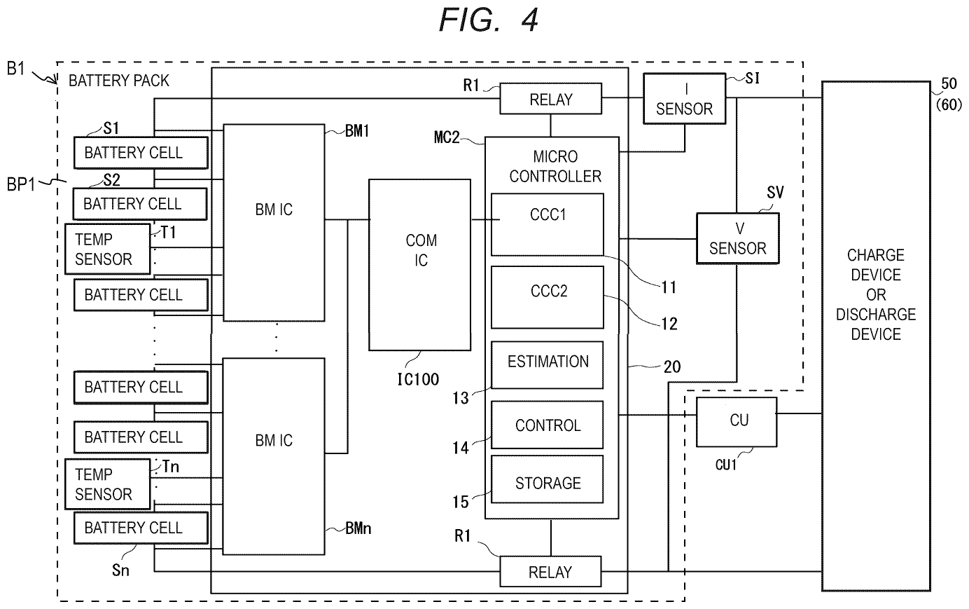

Hereinafter, the configuration of the battery management system and the battery according to the second embodiment will be described with reference to the drawings. FIGS. 3 and 4 are block diagrams showing a battery management system according to a second embodiment. The block diagrams shown in FIGS. 3 and 4 show the block diagram shown in FIG. 1 in detail.

As shown in FIGS. 3 and 4, the battery management system 20 includes a microcontroller MC2 and a battery managing units BM1 to BMn. FIGS. 3 and 4, the type of communication connection between the microcontroller MC2 and the battery managing units BM1 to BMn differs only, and the other configurations are the same.

FIG. 3 is a diagram showing a condition in which the microcontroller MC2 and the battery managing units BM1 to BMn are wirelessly connected to each other. FIG. 4 is a diagram showing a condition in which the microcontroller MC2 and the battery managing units BM1 to BMn are wired to each other. A discharge device 50 or a charge device 60 is connected to a battery pack BP1 for charging or discharging.

As shown in FIGS. 3 and 4, a controller CU1 is connected between the battery pack BP1 and the discharge device 50 or the charge device 60. The controller CU1 arbitrates the battery pack BP1 with the discharge device 50 or the charge device 60. More specifically, the controller CU1 queries the respective devices to determine whether the discharge device 50, the charge device 60, and the battery managing system 20 are operating correctly prior to charging and discharging. Then, the controller CU1 requests the respective devices to charge or discharge after checking that the discharge device 50, the charge device 60, and the battery managing system 20 are operating correctly. Incidentally, if the discharge device 50 or the charge device 60 has a function of arbitration, it may not be provided a controller CU1. In the embodiment to be described later, the discharging device 50 or the charging device 60, the configuration of the controller CUI is the same, not described.

As shown in FIGS. 3 and 4, the microcontroller MC2 includes a first communication connection checking unit (CCC1) 11, a second communication connection checking unit (CCC2) 12, an estimating unit (ESTIMATION) 13, a control unit (CONTROL) 14, and a storage unit (STORAGE) 15.

The battery managing units BM1 to BMn are described below. As shown in FIG. 3, in the battery B1, a plurality of battery managing units BM1 to BMn is included in the battery pack BP1. Further, in the battery B1, a plurality of battery cells S1 to Sn is included in the battery pack BP1.

A plurality of battery cells S1 to Sn are distributed and connected to each battery managing units BM1 to BMn. Thus, the battery managing units BM1 to BMn obtains the cell voltages of the plurality of battery cells S1 to Sn. In the following, the battery cells S1 to Sn are referred to as the cells S1 to Sn.

Further, each of temperature sensors T1 to Tn are connected to each of the battery managing units BM1 to BMn. The temperature sensors T1 to Tn measure the pack temperature of the battery pack BP1. Thus, the battery managing units BM1 to BMn obtain the pack temperature of the battery pack BP1.

Thus, the battery managing units BM1 to BMn obtain the cell voltages of the plurality of cells S1 to Sn and the pack temperature of the battery pack BP1.

The first communication connection will be described. The first communication connection is a communication connection that connects the microcontroller MC2 and the battery managing units BM1 to BMn. The first communication connection is not limited to the wireless connection shown in FIG. 3, may be wired connection as shown in FIG. 4.

That is, as shown in FIG. 3, the microcontroller MC2 and the battery managing units BM1 to BMn are not limited to being wirelessly connected via wireless ICs (Integrated Circuits) IC1 to ICn and wireless IC IC101. As shown in FIG. 4, the microcontroller MC2 and the battery managing units BM1 to BMn may be wired connected via a communication IC 100.

The first communication connection checking unit 11 shown in FIGS. 3 and 4 checks the communication state of the first communication connection. More specifically, the first communication connection checking unit 11 determines whether the communication state of the first communication connection is a disconnected state or not.

The measuring unit will be described. The measuring unit consists of a voltage sensor SV and a current sensor SI. As shown in FIG. 3, the battery pack BP1 includes the voltage sensor SV and the current sensor SI. The voltage sensor SV measures the pack voltage of the battery pack BP1. The current sensor SI measures the pack current of the battery pack BP1.

The second communication connection will be described. The second communications connection connects the microcontroller MC2 and the voltage sensor SV and the current sensor SI. As shown in FIGS. 3 and 4, the second communication connection is a wired connection.

The second communication connection checking unit 12 shown in FIGS. 3 and 4 checks the communication state of the second communication connection. More specifically, the second communication connection checking unit 12 determines whether the communication state of the second communication connection is a disconnected state or not.

The microcontroller MC1 and the battery managing unit BM1 are communicated with each other through the first communication coupling. Thus, the microcontroller MC1 obtains the cell voltage of the cells S1 to Sn and the pack temperature of the battery pack BP1.

In addition, the microcontroller MC1 and the measuring unit M1 are communicated with each other through the second communication coupling. Thus, the microcontroller MC1 obtains the pack voltage and pack current of the battery pack BP1.

That is, when the first communication connection and the second communication connection are in a communication state, the microcontroller MC1 obtains the cell voltages of the plurality of cells S1 to Sn, the pack temperature of the battery pack BP1, the pack voltage of the battery pack BP1, and the pack current of the battery pack BP1.

### (When the First Communication Connection and the Second Communication Connection are Connected)

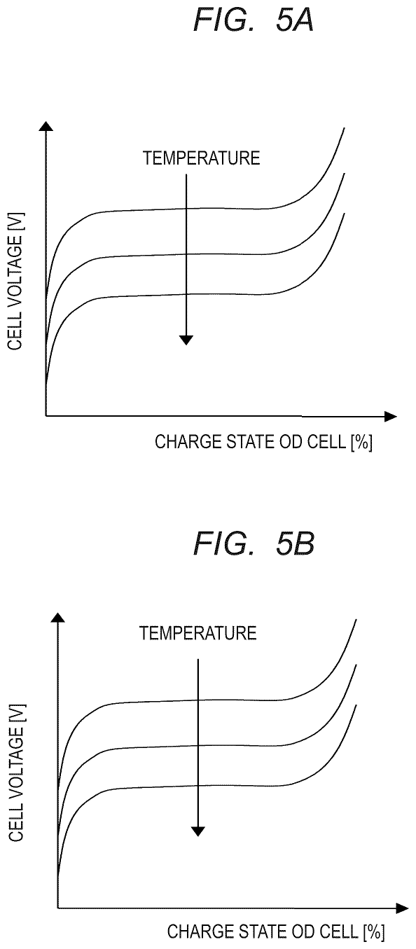

Subsequently, when the first communication connection and the second communication connection is a communication state, the information stored by the storage unit 15 will be described. FIG. 5 is a diagram showing a relationship between a charging state of a cell and a cell voltage, and a relationship between a charging state of a battery and a pack voltage.

The microcontroller MC2 obtains the cell voltage and pack temperature. Thus, as shown in FIG. 5A, the storage unit 15 stores the relationship between the charging state and the cell voltage of the cell at each temperature. In FIG. 5A, three curves with different temperatures are shown. In FIG. 5A, when the temperature becomes lower, even in the state of charge of the same cell, the necessary cell voltage decreases.

The microcontroller MC2 obtains the pack voltage and pack temperature. Thus, the storage unit 15 stores the relationship between the charging state of the battery and the pack voltage at each temperature as shown in FIG. 5B. In FIG. 5B, three curves with different temperatures are shown. In FIG. 5B, when the temperature becomes lower, even in the state of charge of the same cell, the required pack voltage decreases.

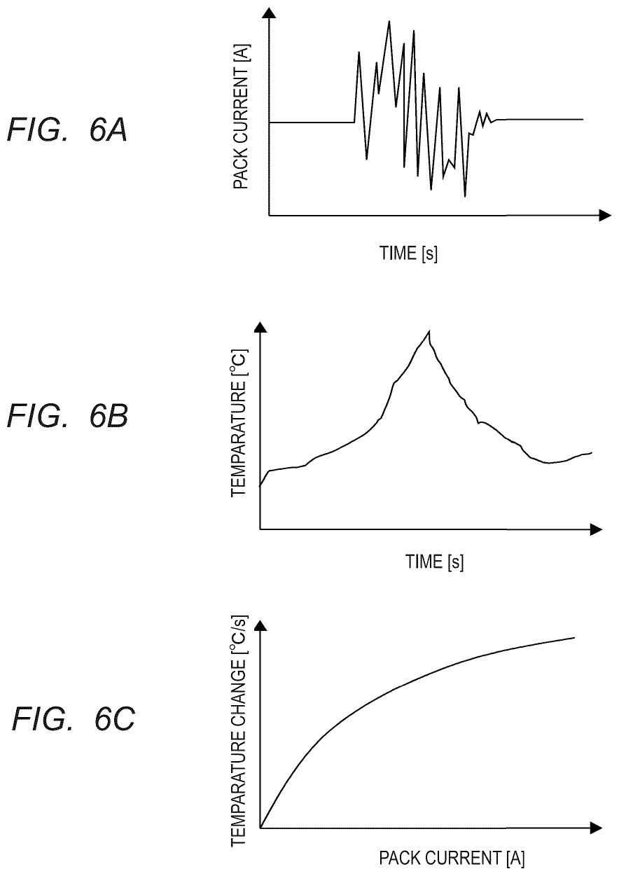

The microcontroller MC2 obtains the pack temperature and the pack current. Thus, the storage unit 15 stores the relationship between the pack current and the pack temperature change during charging and discharging. FIG. 6 is a diagram showing a change in the pack current with respect to time, a change in the pack temperature in response to time, and a relationship between the pack current and the pack temperature change.

As shown in FIGS. 6A and 6B, the storage unit 15 stores a change in the pack current in response with respect to time and a change in the pack temperature with respect to time. The microcontroller MC2 calculates the relationship between the pack current and the pack temperature change shown in the lower stage of FIG. 6 using the change in the pack current with respect to the time shown in FIG. 6A and the change in the pack temperature with respect to the time shown in FIG. 6B. Then, the storage unit 15 stores the relationship between the pack current and the pack temperature change shown in FIG. 6C.

### (Estimation of the State of Charge of the Cell and the State of Charge of the Battery Pack)

Next, when the first communication connection and the second communication connection are in the communication state, the estimation method of the charging state of the cell and the charging state of the battery of the estimating unit 13 will be described.

The microcontroller MC2 obtains the cell voltages/pack temperatures of the cells. The estimating unit 13 estimates the charge state of the cell from the cell voltage and the pack temperature obtained by the microcontroller MC2 using FIG. 5A.

More specifically, it will be described. The estimating unit 13 specifies, among the curved lines in FIG. 5A, the curve having a pack temperature obtained by the microcontroller MC2. Then, the estimating unit 13 specifies the charge state of the cell having the cell voltage obtained by the microcontroller MC2 from the curve. In this way, the estimating unit 13 estimates the charging state of the cell.

The microcontroller MC2 obtains the pack temperature and pack voltage of a plurality of cells. The estimating unit 13 estimates the charge state of the battery pack BP1 from the pack voltage obtained by the microcontroller MC2 and the pack temperature using FIG. 5B.

More specifically, it will be described. The estimating unit 13, among the curved lines in FIG. 5B, identifies a curve having a pack temperature obtained by the microcontroller MC2. Then, the estimating unit 13 specifies the charge state of the battery B1 having the pack voltage obtained by the microcontroller MC2 from the curved line. Thus, the estimating unit 13 estimates the charge state of the battery B1.

As such, in the battery management system 20, the storage unit 15 stores the information in FIGS. 5A, 5B and 6A to 6C. Therefore, when the first communication connection and the second communication connection are in the communication state, the battery management system 20 can estimate the charging state of the cell or the charging state of the battery B1 based on the information of the storage unit 15. The storage unit 15 may store the charge state and the pack temperature of the battery B1 in association with the time.

### (When the First Communication Connection and the Second Communication Connection are Disconnected)

Subsequently, the first communication connection and the second communication connection will be described in the case of a disconnected state. Storage unit 15, shown in FIGS. 5A and 5B, the relationship between the state of charge and the cell voltage of the cell at each temperature, and stores the relationship between the state of charge and the pack voltage of the battery at each temperature. Here, the configuration of the battery, the estimating unit 13, and the method of estimating the pack temperature and the state of charge of the battery will be described in order.

First, the configuration of the battery when the first communication connection and the second communication connection is disconnected will be described. If the first communication connection is disconnected, this includes cases where the wireless IC IC101 connected to the microcontroller or all wireless ICs IC1 to ICn connected to the battery managing units BM1 to BMn are abnormal. Further, when the second communication connection is in the disconnected state, it includes a case where the voltage sensor SV and the current sensor SI have failed. Incidentally, when the first communication connection and the second communication connection are in the disconnected state, it includes that the communication data corruption occurs.

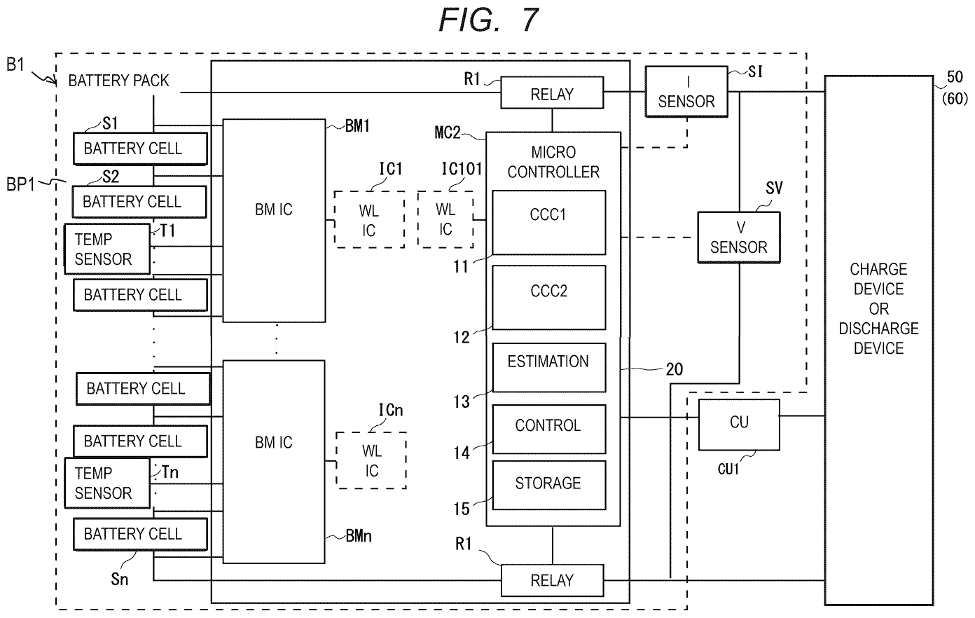

FIG. 7 is a block diagram showing a battery management system according to a second embodiment. As shown in FIG. 7, since the first communication connection is in the disconnected state, it shows the connection of the wireless ICs (WL ICs) IC1 to ICn and the wireless IC (WL IC) IC101 (first communication connection) by a dotted line. Further, as shown in FIG. 7, since the second communication connection is in the disconnected state, it shows the connection between the microcontroller MC2 and the voltage sensor SV and the current sensor SI (second communication connection) by a dotted line.

In the configuration of the battery B1 shown in FIG. 7, the configuration other than the connection state of the first communication connection and the second communication connection is the same as that of FIG. 3. In the following description, the estimating unit 13 estimates the pack temperature and the charge condition of the battery B1 as the charge release information for controlling the charge release of the battery.

When the first communication connection is in the cut state and the second communication connection is in the disconnected state, the estimating unit 13 estimates the pack temperature and the charge state of the battery B1 as follows.

The estimating unit 13 estimates the pack temperature and the state of charge of the battery B1, based on the pack temperature obtained by the microcontroller MC2 before the first communication connection is disconnected and the pack voltage obtained by the microcontroller MC2 before the second communication connection is disconnected.

It will be more specifically described with reference to FIG. 5B. The storage unit 15 stores the relationship between the charging state of the battery and the pack voltage at each temperature shown in FIG. 5B. The estimating unit 13, among the curved lines in FIG. 5B, identifies a curve having a pack temperature obtained by the microcontroller MC2. Then, the estimating unit 13 specifies the charge state of the battery B1 having the pack voltage obtained by the microcontroller MC2 from the curved line.

Thus, by using the pack temperature obtained by the microcontroller MC2 before the first communication connection is disconnected and the obtained by the voltage pack microcontroller MC2 before the second communication connection is disconnected, the estimating unit 13 can estimate the charge state of the battery B1. Further, the estimating unit 13 estimates the pack temperature obtained by the microcontroller MC2 as the temperature of the battery pack BP1 before the first communication connection is disconnected.

Thus, the battery management system 20 can estimate the pack temperature and the state of charge of the battery B1 even when the first communication connection and the second communication connection are in the disconnected state and the measured results (cell voltage, pack temperature, pack voltage, and pack current) are not sufficiently obtained.

Here, the estimating unit 13 estimates the pack temperature and the state of charge of the battery from the pack temperature obtained by the microcontroller MC1 before the first communication connection is disconnected and the pack voltage obtained by the microcontroller MC2 before the second communication connection is disconnected. Since the microcontroller MC2 periodically stores the pack temperature and the charge state in the storage unit 15, the estimating unit 13 may estimate the temperature stored in the microcontroller MC1 to be the pack temperature prior to the first communication connection being disconnected. Furthermore, the estimating unit 13 may that the charging state stored in the microcontroller MC1 is the charging state of the battery prior to the second first communication connection and communication connection being disconnected.

### Example of Control

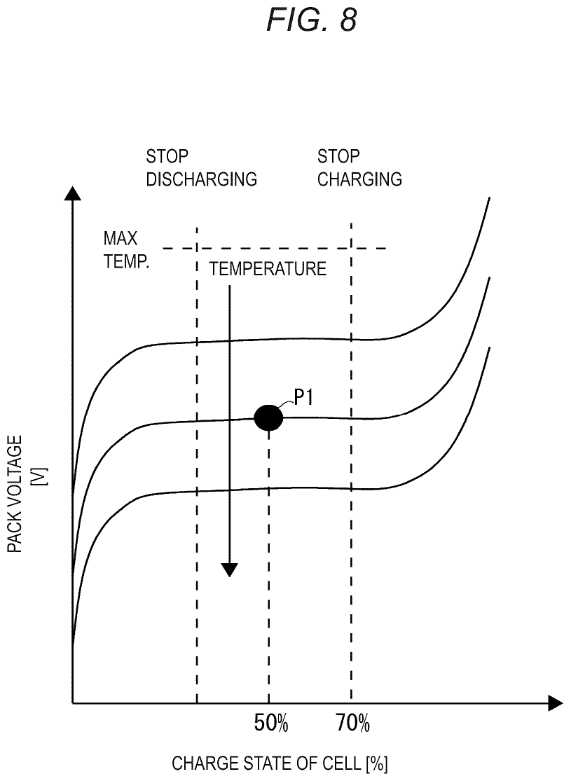

Here, FIG. 3, with reference to FIG. 8, the control unit 14 will be described. FIG. 8 is a diagram showing the relationship between the charging state and the pack voltage of the battery at each temperature. The control unit 14 controls to continue discharging or charging from the state of charge of the temperature and the battery B1 estimated by the estimating unit 13. Further, the control unit 14 controls the relay B1 of FIG. 3 and cuts off the charging/discharging of the battery R1 when the temperature and the charge state of the battery B1 estimated by the estimating unit 13 exceed a predetermined value.

In FIG. 8, a point P1 that is determined from the pack temperature and the charge state of the battery B1 estimated by the estimating unit 13 is showed. In FIG. 8, the charge state of the charge stopping state or discharge stopping state is shown by a dotted line. When the battery B1 charges, the point P1 moves to the right along the curved line to the charge-stop condition. When the battery B1 is discharged, the point P1 moves to the left along the curved line so as to face the discharge stopped condition.

The control unit 14 calculates the remaining time indicating the time from the state of charge of the battery estimated by the estimating unit 13 (point P1) until the state of charge of the discharging stop state or the charging stop state. Referring to FIG. 8, specifically described with reference to the case of charging as an example.

As shown in FIG. 8, the charging stop state is 70%, if the charging state of the point P1 is 50%, the control unit 14 determines that there is 20% remaining charge until it reaches the charging stop state. The control unit 14, by dividing the charging remaining amount by a predetermined pack current, calculates the remaining time indicating the time until the charging state of the charging stop state. The predetermined pack current is, for example, the maximum charging current. The same applies to discharges. Then, the control unit 14, during the remaining time, controls to continue discharging or charging.

As such, the battery management system 20 according to the second exemplary embodiment calculates the remaining time indicating the time from the charging state of the battery estimation by the estimating unit 13 to the charging state of the discharging stop state or the charging stop state. The battery management system 20 then controls to continue discharging or charging for the remaining time. The method of controlling the discharging or charging of such a battery is the same in the third and fourth embodiments described below.

With this configuration, when the first communication connection and the second communication connection are disconnected, the battery management system 20 can continuously charge and discharge the battery for a certain period of time. For example, when a battery B1 in which a battery management system 20 is used is mounted in an electric vehicle, the following can be utilized.

Even if the first communication connection and the second communication connection are in the disconnected state, the control unit 14 controls the relayed R1 so that the estimating unit 13 continues to discharge or charge from the estimated temperature and the state of charge of the battery without interrupting the charging and discharging of the battery B1. Thus, it is possible to secure a certain time until the electric vehicle in running runs to the side of the carriageway. That is, when a battery in which the battery management system 20 is used is mounted in the electric vehicle, it is possible to realize the degeneration operation of the electric vehicle.

Here, the control unit 14, by dividing the charging remaining amount by a predetermined pack current, and calculates the remaining time. Then, the control unit 14, during the calculated remaining time remaining time was described as controlling to continue discharging or charging. However, not limited thereto, the control unit 14, during the time obtained by shortening the calculated remaining time, it may be allowed to continue discharging or charging. With such a configuration, the control unit 14 can be controlled to continue discharging or charging more safely.

In FIG. 8, the maximum temperature of the pack temperature of the battery pack BP1 is shown. In general, the pack temperature increases with charge/discharge. The control unit 14 controls the relay R1 of FIG. 3 and cuts off the charging and discharging of the battery when the pack temperature estimated by the estimating unit 13 becomes the maximum temperature or higher. Thus, it is possible to ensure safety.

Here, the cells in the battery pack tend to increase in order to increase the capacity and efficiency of the battery. With the increase of cells, when the battery management unit increases, the communication line between the battery management unit and the communication IC (FIG. 3) increases.

However, compared with FIG. 4, in FIG. 3, since the first communication connection is a wireless connection, it is possible to solve such a problem. Further, as shown in FIG. 3, when the first communication connection is a wireless connection, it is possible to suppress an increase in man-hours at the time of assembly of the battery pack and repair of the battery management system. Furthermore, as shown in FIG. 3, when the first communication connection is a wireless connection, when the layout of the battery, it is not necessary to redesign the communication line path. In addition, as shown in FIG. 3, when the first communication connection is a wireless connection, the capacity of the cell can be increased because the space of the communication line can be allocated to the space of the cell.

### Third Embodiment

### (When the First Communication Connection is Disconnected and the Second Communication Connection is Communication)

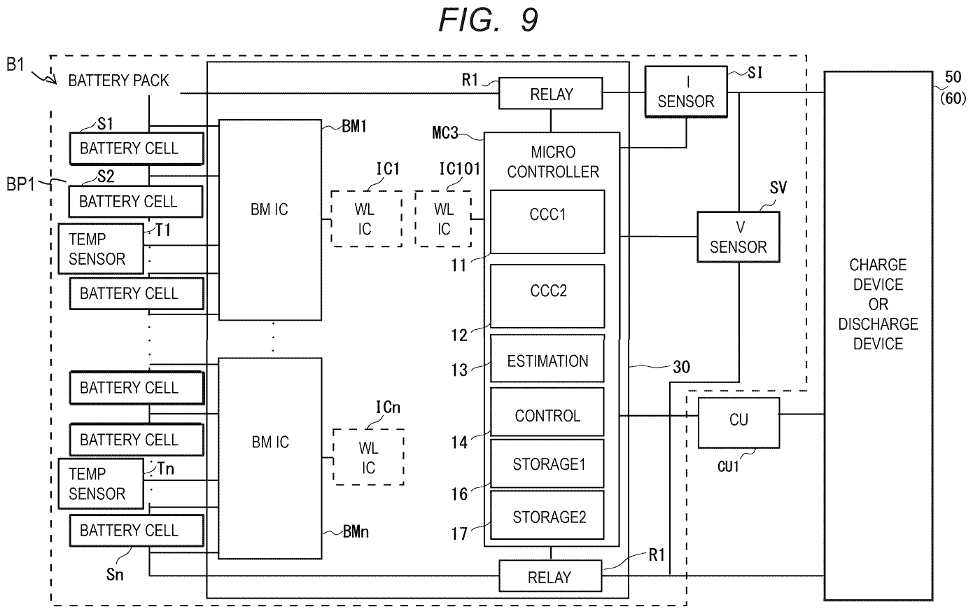

Next, the configuration of the battery management system and the battery according to the third embodiment will be described. FIG. 9 is a block diagram showing a battery management system according to a third embodiment. The battery management system 30 includes a microcontroller MC3 and battery managing units BM1 to BMn. The microcontroller MC3 includes a first communication connection checking unit (CCC1) 11, a second communication connection checking unit (CCC2) 12, an estimating unit (ESTIMATION) 13, a control unit (CONTROL) 14, a first storage unit (STORAGE1) 16, and a second storage unit (STORAGE2) 17.

The first communication connection checking unit 11, the second communication connection checking unit 12, the control unit 14 shown in FIG. 9, the description thereof will be omitted because it is the same as in the second embodiment. Hereinafter, the configuration of the battery, the first storage unit 16, the second storage unit 17, and the estimating unit 13 will be described in detail in this order.

First, the configuration of the battery will be described. In FIG. 9, the first communication connection is a disconnected state, and since the second communication connection is a communication state, the connection of the wireless ICs IC1 to ICn and the wireless IC IC101 (first communication connection) is shown by a dotted line.

Next, the first storage unit 16 and the second storage unit 17 will be described. The first storage unit 16 stores the relationship between the charging state and the cell voltage of the cell at each temperature and the relationship between the charging state and the pack voltage of the battery at each temperature as shown in FIGS. 5A and 5B. That is, the first storage unit 16 stores the cell voltage, the state of charge of the cell, the corresponding information of the pack temperature (in FIG. 5A), the pack voltage, the state of charge of the battery, and the corresponding information of the pack temperature (in FIG. 5B).

The second storage unit 17 stores the relationship between the change of the pack current with respect to time, the change of the pack temperature with respect to time, and the pack current and the pack temperature change shown in FIGS. 6A to 6C. The first storage unit 16 and the second storage unit 17 periodically stores the pack temperature obtained by the microcontroller MC3, the charging state of the cell, and the charging state of the battery.

As shown in FIG. 9, since the second communication connection is in a communication state, the microcontroller MC3 can obtain the pack current. Therefore, the microcontroller MC3 can detect that the battery B1 is in charging state when it detects that the current is flowing. On the other hand, the microcontroller MC3 can detect that the battery is idle if it detects that no current is flowing.

In the following, the estimating unit 13 will be described separately from the case where the battery is in the dormant state and the case where the battery is in the charged state. In the following description, the estimating unit 13 will be described as estimating the pack temperature and the charging state of the battery as the charging information for controlling the discharging and charging of the battery.

### (When the Battery is in Hibernation)

When the battery is in the dormant state, a method in which the estimating unit 13 estimates the temperature and the charging state will be described. First, a method of estimating the temperature on the basis of information (in FIG. 5B) stored in the first storage unit 16 by the estimating unit 13 will be described.

As shown in FIG. 9, the microcontroller MC3 can obtain the pack voltage because the second communication connectivity is in a communication condition. The first storage unit 16, prior to the first communication connection is disconnected, stores the charge state of the battery microcontroller MC3 has obtained.

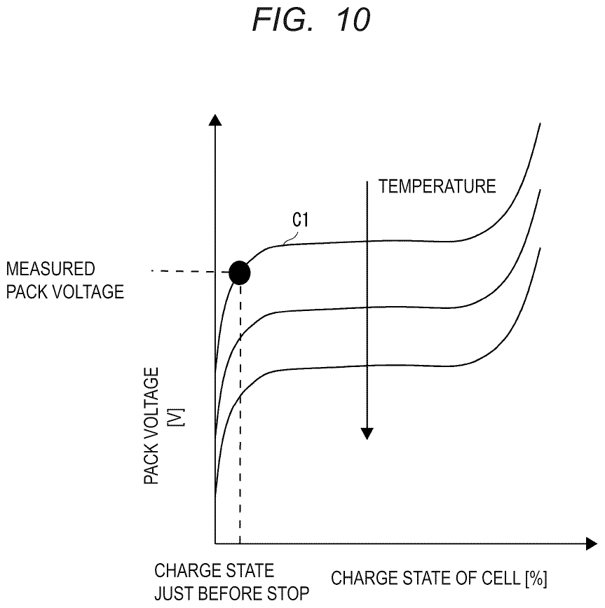

From this, the estimating unit 13 estimates the pack temperature by using the relationship between the charging state and the pack voltage at each temperature stored in the first storage unit 16 (in FIG. 5B). It will be more specifically described with reference to FIG. 10. FIG. 10 is a diagram showing the relationship between the state of charge of the battery and the pack voltage at each temperature. FIG. 10 is the same as FIG. 5B and is an explanatory diagram for explaining the estimating unit 13 in more detail.

As shown in FIG. 10, the estimating unit 13 can estimate, among the temperatures of the first storage unit 16, the temperature corresponding to the charging state of the battery before the pack voltage and the first communication connection are disconnected (immediately before resting) as the pack temperature. In other words, as shown in FIG. 10, the estimating unit 13 estimates the temperature of the curved C1 that satisfies both the pack voltage and the state of the charge of the battery before (immediately before resting) the first communication connection is disconnected as the pack temperature.

Next, a method in which the estimating unit 13 estimates the charging state of the battery based on the information stored in the first storage unit 16 will be described. As described above, the estimating unit 13 estimates the pack temperature. Further, since the second communication connection is in a communication state, the microcontroller MC3 can obtain the pack voltage.

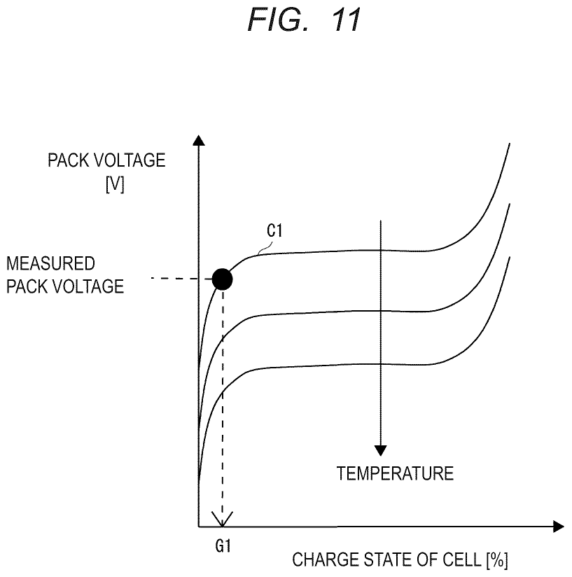

Thus, the estimating unit 13 can estimate the charging state of the battery by using the relationship between the charging state and the pack voltage at each temperature stored in the first storage unit 16 (in FIG. 5B). It will be more specifically described with reference to FIG. 11. FIG. 11 is a diagram showing a relationship between the charge state of the battery cell and the pack voltage at each temperature. FIG. 11 is the same as FIG. 5B is an explanatory diagram for explaining the estimating unit 13 in more detail.

As shown in FIG. 11, the estimating unit 13 can estimate the charging state corresponding to the estimated pack temperature and the pack voltage obtained by the microcontroller MC3 as the charging state of the battery. In other words, as shown in FIG. 11, the estimating unit 13 estimations the charging state G1 having the pack voltage obtained by the microcontroller MC3 from the curve C1 of the estimated pack temperature as the charging state of the battery.

Thus, when the battery is in a hibernation state, the battery management system 30 can estimate the pack temperature and the state of charge of the battery in order to control the charge/discharge even if the measurement results (cell voltage, pack temperature) are not sufficiently obtained.

Incidentally, the pack temperature varies with the ambient temperature as the time elapses from the timing when the battery becomes idle. Therefore, the estimating unit 13 estimates the pack temperature and estimates the charging state of the battery by using FIG. 10. With such a configuration, the battery management system 30 can accurately estimate the pack temperature and the state of charge of the battery even when the battery changes from the temperature and state of charge of the timing when the battery is in a dormant state.

### (When the Battery is in the Release State of Charge)

When the battery is in the state of charge/discharge, the estimating unit 13 will be described a method for estimating the temperature and the state of charge. First, a method of estimating the temperature will be described based on the information (in FIG. 6C) stored in the second storage unit 17 by the estimating unit 13. Since the second communication connection is in a communication condition, the microcontroller MC3 can obtain the pack current. The second storage unit 17 stores the pack temperature obtained by the microcontroller MC3 prior to the first communication connection being disconnected.

Thus, the estimating unit 13 can estimate the pack temperature change from the pack current using the relationship between the pack current and the pack temperature change stored in the second storage unit 17 (in FIG. 6C). Then, the estimating unit 13 estimates the temperature obtained by correcting the estimated temperature change as the pack temperature with respect to the pack temperature before the first communication connection is disconnected.

For example, when the pack temperature before the first communication connection is disconnected is 20 degrees and the pack temperature change (rise) estimated by the estimating unit 13 is 3 degrees, the estimating unit 13 estimates that 23 degrees is the pack temperature.

Next, a method in which the estimating unit 13 estimates the charging state will be described. Since the second communication connection is in a communication condition, the microcontroller MC3 can obtain the pack current. The second storage unit 17, prior to the first communication connection is disconnected, stores the charge state obtained by the microcontroller MC3.

Here, the microcontroller MC1 measures the times. Therefore, the estimating unit 13, by multiplying the time with respect to the pack current, can calculate the integrated value of the current. From this, the estimating unit 13 estimates the charging state obtained by correcting the integrated value of the pack current as the charging state of the battery for the charging state of the battery before the first communication connection is disconnected.

Thus, when the battery is in the state of charge/discharge, the battery management system 30 can estimate the pack temperature and the state of charge of the battery in order to control the charge/discharge even if the measurement results (cell voltage, pack temperature) are not sufficiently obtained.

As described above, when the first communication connection is in the disconnected state and the second communication connection is in the communication state, the estimating unit 13 estimates the temperature of the battery pack and the charging state of the battery based on the pack voltage or the pack current. This allows the battery management system 30 to estimate the pack temperature and the state of charge of the battery to control the charge/discharge even if the measurement results are not sufficiently obtained.

### (When the First Communication Connection is in the Communication State and the Second Communication Connection is in the Disconnected State)

When the first communication connection is in a communication state and the second communication connection is in a disconnected state, the microcontroller MC1 is unable to obtain the pack voltage and pack current. On the other hand, the microcontroller MC1 can obtain the cell voltage and the pack temperature because the first communication connection is in communication.

From this, the estimating unit 13 can estimate the charging state of the cell based on the information of FIG. 5A of the first storage unit 16. More specifically, the estimating unit 13 specifies a curve having a pack temperature obtained by the microcontroller MC3 among the curved lines in FIG. 5A. Then, the estimating unit 13 estimates the charging state having the cell voltage obtained by the microcontroller MC3 from the curve as the charging state of the cell.

Then, the estimating unit 13 estimates the charging state of the battery from the charging state of the cell. More specifically, when the battery is the charging state, the estimating unit 13 estimates the highest charging state among the charging states of the cells as the charging state of the battery. In addition, when the battery is in the discharged state, the estimating unit 13 estimates the lowest charged state among the charged states of the cells as the charged state of the battery.

Incidentally, the estimating unit 13, at a predetermined time interval, estimates the state of charge of the cell. Thus, the estimating unit 13, the charging state obtained by subtracting the charging state of the cell before a predetermined time has elapsed from the charging state of the cell after a predetermined time has elapsed, by dividing by a predetermined time, it can estimate the pack current.

### Fourth Embodiment

### (When the Connection Between the Microcontroller and the Battery Management Section is Disconnected)

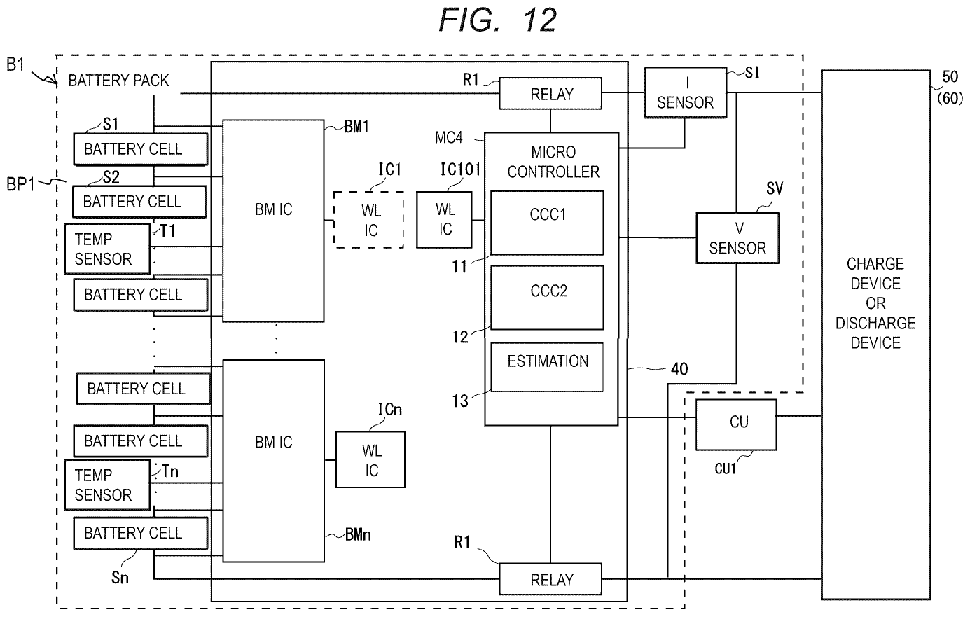

Next, the configuration of the battery management system and the battery according to the fourth embodiment will be described. FIG. 12 is a block diagram showing a battery management system according to a fourth embodiment. The battery management system 40 includes a microcontroller MC4 and battery managing units BM1 to BMn. The microcontroller MC4 includes a first communication connection checking unit (CCC1) 11, a second communication connection checking unit (CCC2) 12, and an estimating unit (ESTIMATION) 13.

The first communication connection checking unit 11 and the second communication connection checking unit 12 shown in FIG. 12, the description thereof will be omitted because it is the same as the first to third embodiments. In the following, the configuration of the battery, the estimating unit 13 will be described in detail in order. Although not shown in FIG. 12, the microcontroller MC4 may include a control unit as in the second and third embodiments.

First, the configuration of the battery will be described. If some of the connections between the microcontroller MC4 and the battery managing units BM1 to BMn are disconnected, the wireless IC101 connected to the microcontroller is normal and some of the wireless ICs IC1 to ICn connected to the battery managing units BM1 to BMn are abnormal.

In FIG. 12, since the wireless IC IC1 of the battery management unit BM1 is abnormal and the connection (part of the first communication connection) between the microcontroller MC4 and the battery managing unit BM1 is disconnected, the wireless IC IC1 is indicated by a dotted line. In the following description, the estimating unit 13 will be described as estimating the pack temperature and the state of charge of the battery as the charge/discharge information for controlling the charge/discharge of the battery.

Since the connection (part of the first communication connection) between the wireless IC IC1 and wireless IC IC101 is disconnected, the microcontroller MC4 is unable to obtain the cell voltage and pack temperature in the battery managing unit BM1.

In this instance, the estimating unit 13 estimates the cell voltage and the pack temperature which are obtained by the microcontroller MC4 from the battery managing unit BM1 in the following manner. The estimating unit 13 determines the cell voltage and the pack temperature obtained by the microcontroller MC1 as the cell voltage and the pack temperature obtained by any of the battery managing units BM2 to BMn that can be communicatively connected to the microcontroller MC1.

In other words, the estimating unit 13 substitutes the cell voltage and the pack temperature from the battery managing unit BM1 with the cell voltage and the pack temperature from the other battery managing units BM2 to BMn. Then, the estimating unit 13 estimates the pack temperature of the battery pack and the state of charge of the battery.

With such a configuration, the battery management system 40 can estimate the pack temperature and the state of charge of the battery in order to control the discharging charge even though the measured results (the cell voltage and the pack temperature below the battery managing unit BM1) are not sufficiently obtained.

Since the pack temperature depends on the ambient temperature, a temperature difference occurs, for example, in the battery management section located at both ends of the battery. Therefore, it is preferable that the estimating unit 13 substitute the cell voltage and the pack temperature from the battery managing unit BM1 with the cell voltage and the pack temperature from the battery managing unit BM2 disposed adjacently to the battery managing unit BM1. With this configuration, the estimating unit 13 can estimate the cell voltage and the pack temperature from the battery managing unit BM1 more precisely.

Here, it is explained that the wireless IC1 of the battery managing unit BM1 is abnormal. The battery management system 40 can similarly estimate the cell voltage and the pack temperature from the battery managing units BM1 to BMn even when the wireless ICs IC1 to ICn of the battery managing units BM1 to BMn are abnormal. That is, when any or a plurality of wireless ICs IC1 to ICn connected to the battery managing units BM1 to BMn is abnormal, the battery management system 40 replaces the cell voltage and the pack temperature from the other battery managing units BM2 to BMn where communication is normal.

It should be understood that the graphs shown in FIGS. 5, 6, 8, 10, and 11 are only examples schematically shown, and are not limited to the shapes shown in the respective drawings.

Although the invention made by the inventor has been specifically described based on the embodiment, the present invention is not limited to the embodiment already described, and it is needless to say that various modifications can be made without departing from the gist thereof.

From the first to the fourth embodiments, each functional block such as the estimating unit 13 is described as a configuration in which the microcontroller has. However, the invention is not limited thereto, and the configuration may be such that each functional block is provided in the battery management system.

Furthermore, some or all of the processes of the battery management systems 10 to 40 can be implemented by having CPU (Central Processing Unit) run a computer program.

The program described above includes a set of instructions (or software code) for causing the computer to perform one or more of the functions described in the embodiments when read into the computer. The program may be stored on a non-temporary computer-readable medium or on a tangible storage medium. By way of example and not limitation, computer-readable media or tangible storage media include: RAM (Random-Access Memory), ROM (Read-Only Memory, flash memory, SSD (Solid-State Drive) or other memory techniques, CD-ROM, DVD (Digital Versatile Disc), Blu-ray (registered trademark) disks or other optical disk storage, magnetic cassettes, magnetic tapes, magnetic disk storage or other magnetic storage devices. The program may be transmitted on a temporary computer-readable medium or communication medium. By way of example and not limitation, temporary computer readable media or communication media include electrically, optically, acoustically, or other forms of propagating signals.

What is claimed is:

1. A battery management system comprising:
a microcontroller;
a battery managing unit for obtaining a cell voltage of a plurality of cells and a pack temperature of a battery pack;
a measuring unit for measuring a pack voltage and a pack current of the battery pack;
a first communication connection checking unit for checking a first communication state of a first communication connection that connects the microcontroller and the battery managing unit;
a second communication connection checking unit for checking a second communication state of a second communication connection that connects the microcontroller and the measuring unit; and
an estimating unit for estimating charge/discharge information for controlling charge/discharge of the battery pack based on information obtained by the microcontroller, in response to the first communication state and the second communication state.

2. The battery management system according to claim 1, wherein the charge/discharge information includes the pack temperature and a charging state of the battery pack.

3. The battery management system according to claim 2 further comprising a control unit for controlling the charge/discharge of the battery pack,
wherein the control unit calculates a remaining time indicating the time it takes to reach a charging state from a discharge stopping state or a charge stopping state based on the charge/discharge information estimated by the estimating unit, and controls to continue discharging or charging during the remaining time.

4. The battery management system according to claim 2,
wherein the estimating unit estimates the pack temperature and the charging state of the battery pack, based on the pack temperature of the battery pack obtained by the microcontroller before the first communication connection is disconnected and the pack voltage obtained by the microcontroller before the second communication connection is disconnected, when the first communication connection and the second communication connection are in a disconnected state.

5. The battery management system according to claim 2,
wherein the estimating unit estimates the pack temperature and the charging state of the battery pack, based on the pack voltage or the pack current of the battery pack, when the first communication connection is in a disconnected state and the second communication connection is in a connected state.

6. The battery management system according to claim 5,
wherein the estimating unit determines whether or not the battery pack is in a hibernation state based on the pack current and estimates the pack temperature and the charging state of the battery pack based on the pack voltage, when the battery pack is in the hibernation state.

7. The battery management system according to claim 6 further comprising a first storage unit storing corresponding information of the pack voltage, the pack temperature and the charging state of the battery pack,
wherein the estimating unit estimates the pack temperature from a temperature corresponding to the pack voltage and the charging state of the battery pack before the first communication connection was disconnected among the temperatures in the first storage unit,
wherein the estimation unit estimates the charging state of the battery pack from charging state corresponding to the estimated pack temperature and the estimated pack voltage.

8. The battery management system according to claim 6,
wherein the estimating unit estimates the pack temperature and the charging state of the battery pack based on the pack current, when the battery pack is in the charging/discharging state.

9. The battery management system according to claim 8 further comprising a second storage unit storing the pack current and temperature changes,
wherein the estimating unit estimates the pack temperature from a temperature obtained by correcting a temperature change corresponding to the pack current among the temperature changes in the second storage unit, with respect to the pack temperature before the first communication connection is disconnected,
wherein the estimating unit estimates the charging state of the battery pack from a charging state of the battery pack obtained by correcting the integrated value of the pack current with respect to a charging state of the battery before the first communication connection is disconnected.

10. The battery management system according to claim 2,
wherein the first communication connection is configured by connecting a plurality of the battery managing units to the microcontroller,
wherein the estimating unit estimates the pack temperature and the charging state of the battery pack from the cell voltage and the pack temperature obtained by the microcontroller from the battery managing unit which is in a disconnected state with the microcontroller, as the cell voltage and the pack temperature obtained by the microcontroller from a battery management unit, which can be communicatively connected with the microcontroller when a part of the connections between the microcontroller and the plurality of the battery managing units is disconnected in the first communication connection.

11. The battery management system according to claim 10,
wherein the battery managing unit can be communicatively connected to the microcontroller and is disposed adjacent to the battery managing unit that is in a disconnected state with the microcontroller.

12. A battery management method for the battery management system according to claim 1, the battery management method comprising the steps of:
checking the communication state of the first communication connection connecting the microcontroller and the battery management unit, which obtains the cell voltages of the plurality of cells and the pack temperature of the battery pack;
checking the communication state of the second communication connection connecting the microcontroller, the measuring unit for measuring the pack voltage and pack current of the battery pack; and
estimating charge/discharge information for controlling charge/discharge of the battery pack based on information the microcontroller can obtain, in response to the communication state of the first communication connection and the second communication connection.

13. A program comprising program instructions for causing a computer to perform the battery management method according to claim 12.
